(19) United States
(12) Patent Application Publication
(10) Pub. No.: US 2026/0257313 A1
(43) Pub. Date: Sep. 3, 2026

(54) ELECTRIC WORK MACHINE AND ANGLE TOOL

(71) Applicant: MAKITA CORPORATION, Anjo-shi (JP)

(72) Inventors: Naoki SOEDA, Anjo-shi (JP); Masatoshi NAKAHAMA, Anjo-shi (JP)

(73) Assignee: MAKITA CORPORATION, Anjo-shi (JP)

(21) Appl. No.: 19/547,815

(22) Filed: Feb. 24, 2026

(30) Foreign Application Priority Data
Feb. 28, 2025 (JP) 2025-032146

(51) Int. Cl. B24B 23/02; B25F 5/00; B25F 5/02

(52) U.S. Cl. CPC B24B 23/028; B25F 5/001; B25F 5/008; B25F 5/02

(57) ABSTRACT

An electric work machine includes a first housing, a second housing, and a fan. The first housing houses a motor. The second housing is disposed on an axis of a motor shaft of the motor and houses electrical components other than the motor. The fan rotates with a drive of the motor. A cooling passage through which air drawn by the rotation of the fan passes is formed in the first housing and the second housing. An intake air passage is formed in the second housing as a part of the cooling passage and includes an intake opening for drawing in air from a radially outer side of the motor shaft and an outlet opening for exhausting air toward the motor side in proximity to the motor in an axial direction of the axis.

### CROSS REFERENCE TO RELATED APPLICATION

This application claims the benefit of Japanese Patent Application Number 2025-032146 filed on February 28, 2025, the entirety of which is incorporated by reference

### FIELD OF THE INVENTION

The present disclosure relates to an electric work machine, such as a grinder, and to an angle tool in which an output shaft is orthogonal to a motor shaft.

### BACKGROUND OF THE INVENTION

A grinder, which is one example of an electric work machine, performs polishing and grinding of a workpiece by rotating a tip tool attached to an output shaft at a front portion thereof, and the rotation is driven by a motor built into a housing that extends in a front-rear direction.

For example, JP2023-55115A discloses a grinder provided with a rear cover that houses a controller and a switch at a rear portion of a motor housing that houses a motor, so that an operator can grasp the rear cover. In the grinder, a rotation shaft of the motor is provided with a fan, and intake ports are formed on a side face and a rear face of the rear cover, while exhaust ports are formed on a gear housing that houses an output shaft, respectively, whereby a cooling passage is formed in its interior. Specifically, when the fan rotates with the rotation shaft, an airflow is generated within the cooling passage, and the air drawn in through the rear intake port passes through the controller and the motor before being discharged through the exhaust ports, thereby allowing cooling of the controller and the motor.

In the conventional grinder described above, there was a possibility that the dust drawn in from the intake port together with the outside air during the operation would adhere to electrical components such as the switch and the controller, thereby becoming a cause of a failure due to a short circuit or the like. There was also a concern that, if the side intake port were blocked by a hand of an operator grasping the rear cover, the reduction in the airflow rate would occur and the cooling performance of the controller and the motor would decrease.

Accordingly, the objective of the present disclosure is to provide an electric work machine that can suppress an occurrence of the failures caused by the foreign matter drawn into the cooling passage, as well as suppress a degradation of the cooling performance.

### SUMMARY OF THE INVENTION

In order to achieve the above-described object, a first configuration of the disclosure is an electric work machine. The electric work machine includes a first housing, a second housing, and a fan. The first housing houses a motor. The second housing is disposed on an axis of a motor shaft of the motor and houses an electrical component other than the motor. The fan rotates with a drive of the motor. A cooling passage through which air drawn by the rotation of the fan passes is formed in the first housing and the second housing. An intake air passage is formed in the second housing as a part of the cooling passage and includes an intake opening for drawing in air from a radially outer side of the motor shaft and an outlet opening for exhausting air toward the motor side in proximity to the motor in the axial direction.

In order to achieve the above-described object, a second configuration of the disclosure is an angle tool. The angle tool includes a front housing, a first housing, a second housing, and a fan. The front housing includes an output shaft in an up-down direction on which a tip tool is mounted at a lower end of the output shaft. The first housing is positioned behind the front housing, extends in a front-rear direction, and houses a motor including a motor shaft having an axis in the front-rear direction. The second housing is positioned behind the first housing, extends in the front-rear direction, and houses an electrical component other than the motor. The fan rotates with a drive of the motor. A cooling passage is formed in the first housing and the second housing. Air drawn by the rotation of the fan passes through the cooling passage. An intake air passage is formed as a part of the cooling passage in the second housing, has an intake opening that opens radially outer side of the motor shaft and an outlet opening that opens toward a front in the axial direction of the axis, and is proximate to the motor.

According to the present disclosure, since the outlet opening of the intake air passage is close to the motor, the foreign matter that is suctioned with the outside air from the intake opening of the intake air passage during the operation is less likely to adhere to the electrical component, and the possibility of becoming the cause of the failure due to the short circuit or the like is reduced. Additionally, the air passing through the intake air passage is exhausted toward the motor such that the motor is efficiently cooled. Therefore, the occurrence of the failure caused by the foreign matter drawn into the cooling passage can be suppressed, and the decrease in the cooling performance can also be suppressed.

### BRIEF DESCRIPTION OF THE DRAWINGS

FIG. 1 is a perspective view of a grinder of Embodiment 1 from a rear.

FIG. 2 illustrates a central longitudinal sectional view of the grinder of Embodiment 1.

FIG. 3 is a cross-sectional view taken along the line A-A of FIG. 2.

FIG. 4 is a perspective view of an inner housing portion of Embodiment 1 with a rear cover removed.

FIG. 5 is a rear view of the grinder of Embodiment 1.

FIG. 6 is a perspective view of the rear cover of Embodiment 1 as seen from a front.

FIG. 7 is a perspective view of a central longitudinal section of the rear cover of Embodiment 1.

FIG. 8 is a cross-sectional view taken along the line B-B of FIG. 2.

FIG. 9 is an enlarged cross-sectional view taken along the C-C line of FIG. 2.

FIG. 10 is an explanatory diagram enlarging a rear cover portion in FIG. 3 to illustrate an airflow.

FIG. 11 is a perspective view from a rear of a grinder of Embodiment 2.

FIG. 12 is a rear view of the grinder of Embodiment 2.

FIG. 13 is a perspective view of a rear cover of Embodiment 2 as viewed from a front.

FIG. 14 is an explanatory diagram illustrating an airflow, with a portion of the rear cover enlarged in a cross section taken along the line D-D of FIG. 12.

FIG. 15 is an enlarged cross-sectional view taken along the E-E line of FIG. 14.

### DETAILED DESCRIPTION OF THE INVENTION

In one embodiment of the present disclosure, an outlet opening may be located, in an axial direction, between a motor and a central portion of an electrical component.

According to the configuration, an airflow can be made to contact the motor from a position near the motor.

In one embodiment of the present disclosure, an intake air passage may be formed into a tubular shape that extends in the axial direction by a peripheral wall portion of a second housing and an inner wall portion provided inside the peripheral wall portion.

This configuration allows the air to flow smoothly toward the motor, allowing the efficient cooling.

In the one embodiment of the present disclosure, at least a portion of an intake opening may be provided in the peripheral wall portion.

According to the configuration, a wide opening region is secured in the peripheral wall portion, thereby allowing the intake of the necessary air and allowing the efficient cooling.

In one embodiment of the present disclosure, the intake opening provided in the peripheral wall portion may be positioned opposite the inner wall portion.

According to the configuration, even when the foreign matter enters through the intake opening, the inner wall portion can shield it.

In one embodiment of the present disclosure, the inner wall portion may include a flat portion parallel to the axial direction.

According to the configuration, the air drawn in through the intake opening can flow smoothly along the flat portion toward the motor.

In one embodiment of the present disclosure, the flat portion may be parallel to a virtual plane that includes the axis and intersects the electrical component.

According to the configuration, a dead space on an outside of the electrical component can be utilized to provide the inner wall portion, thereby suppressing an enlargement of a second housing.

In one embodiment of the present disclosure, a cross-sectional shape perpendicular to the axis in the intake air passage may be a flat-plate shape parallel to the flat portion.

According to the configuration, it is possible to provide the intake air passage by utilizing the dead space on the outside of the electrical component, thereby suppressing the enlargement of the second housing.

In one embodiment of the present disclosure, a second intake opening in communication with the intake air passage may be provided at an end portion of the second housing on a side opposite to the motor.

According to the present embodiment, the air can flow linearly within the intake air passage, leading to the improvement in the cooling efficiency.

In one embodiment of the present disclosure, the second intake opening may have an oblong shape extending parallel to the flat portion.

According to the present configuration, the second intake opening connected to the intake air passage can be provided in a space-saving manner.

In one embodiment of the present disclosure, the output shaft is inclined at a predetermined angle relative to the motor shaft, and the output shaft may be disposed on the virtual plane.

According to the present configuration, the output shaft can be positioned within the dead space on the virtual plane, thereby suppressing the enlargement in the direction orthogonal to the virtual plane.

In one embodiment of the present disclosure, the intake opening provided in the peripheral wall portion may go through in a direction perpendicular to the virtual plane that includes the axis and intersects the electrical component.

According to the configuration, even in the event that a hand gripping the peripheral wall portion contacts the intake opening, the decrease in the intake airflow rate becomes less likely.

In one embodiment of the present disclosure, the motor is a brushed motor, and the brushes may be positioned at locations other than along an extension of the intake air passage.

According to the present configuration, the brushes can be disposed in the dead space that is free of an interference with the cooling passage, whereby the suppression of the increase in size and the suppression of the decrease in the cooling efficiency are achieved.

In one embodiment of the present disclosure, the electrical component may be the controller that controls the brushed motor.

In the configuration, an adherence of the foreign matter to the controller can be effectively suppressed.

The following description of Embodiment 1 of the present disclosure refers to the drawings.

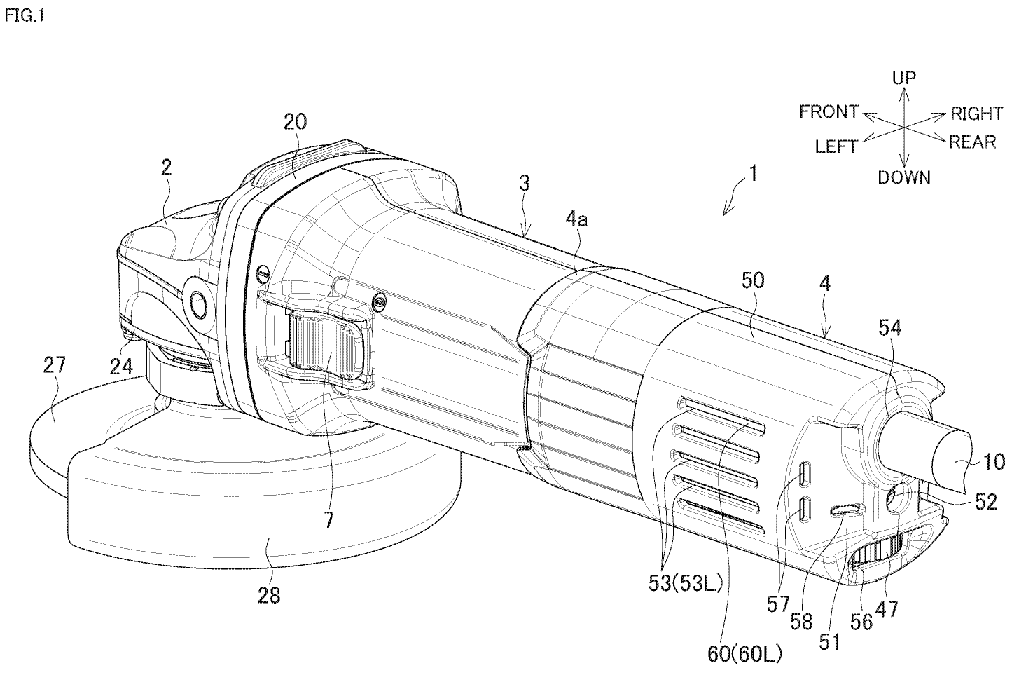

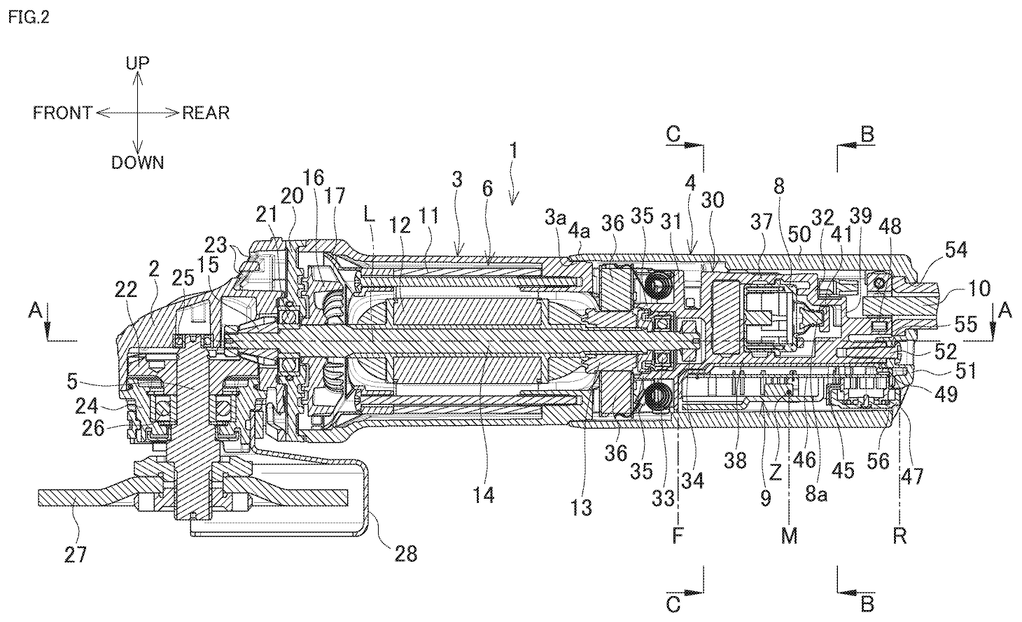

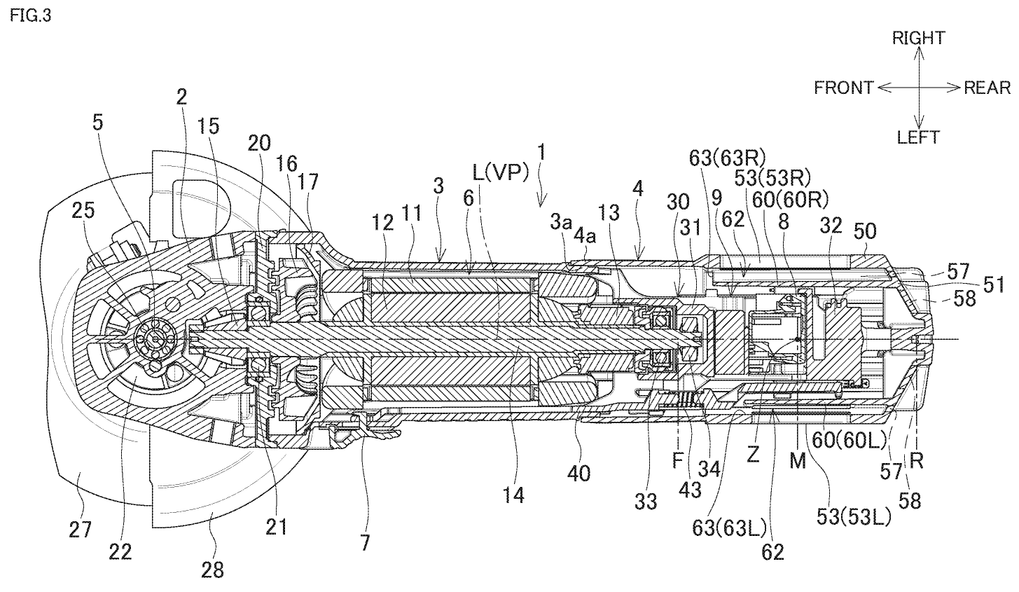

FIG. 1 is a perspective view of a grinder, which is one example of an electric work machine and an angle tool. FIG. 2 is a central longitudinal sectional view of the grinder. FIG. 3 is a cross-sectional view taken along the line A-A in FIG. 2.

A grinder 1 includes, as a housing that forms an outer casing, a gear housing 2, a motor housing 3, and a rear cover 4 from the front. The gear housing 2 is made of metal, and the motor housing 3 and the rear cover 4 are made of resin.

The gear housing 2 includes a spindle 5 that protrudes downward. The spindle 5 is an example of the output shaft of the present disclosure.

The motor housing 3 is of a tubular shape, extends in the front-rear direction, and houses a motor 6. A switch knob 7 is provided on a left side of the motor housing 3 so as to be slidable forward and backward. The motor housing 3 is one example of the first housing of the present disclosure.

The rear cover 4 is of a tubular shape that extends in a front-rear direction, similar to the motor housing 3, and houses a switch 8 and a controller 9. A power cord 10 is connected to a rear portion of the rear cover 4. The rear cover 4 is one example of the second housing of the present disclosure.

The motor 6 is a commutator motor including a stator 11, a rotor 12, and a commutator 13, driven by an alternating-current power supplied from outside. A motor shaft 14 provided on the rotor 12 extends in the front-rear direction, with the front-end protruding into the gear housing 2. A bevel gear 15 is provided at a front end of the motor shaft 14. A fan 16 is provided on the motor shaft 14 at a front of the motor housing 3. The fan 16 is a centrifugal fan, and a baffle plate 17 that widens toward the front is provided on a rear outer periphery thereof.

A gear housing cover 20, through which the motor shaft 14 passes, is provided between the gear housing 2 and the motor housing 3. The gear housing cover 20 is provided with a bearing 21 that supports the motor shaft 14.

A bevel gear 22 is provided on an upper portion of the spindle 5 within the gear housing 2. The bevel gear 22 meshes with a bevel gear 15 on the motor shaft 14. A plurality of exhaust ports 23 are formed in a front surface of the gear housing 2.

A bearing box 24 is assembled to a lower portion of the gear housing 2. The spindle 5 is supported by an upper bearing 25 retained in the gear housing 2 and a lower bearing 26 retained in the bearing box 24. A lower end of the spindle 5 that protrudes from the bearing box 24 is configured to receive a tip tool 27. The tip tool 27 illustrated in FIGS. 1 and 2 exemplifies a disc-shaped grinding wheel. The bearing box 24 is fitted with a tool cover 28 that covers a rear half of the tip tool 27.

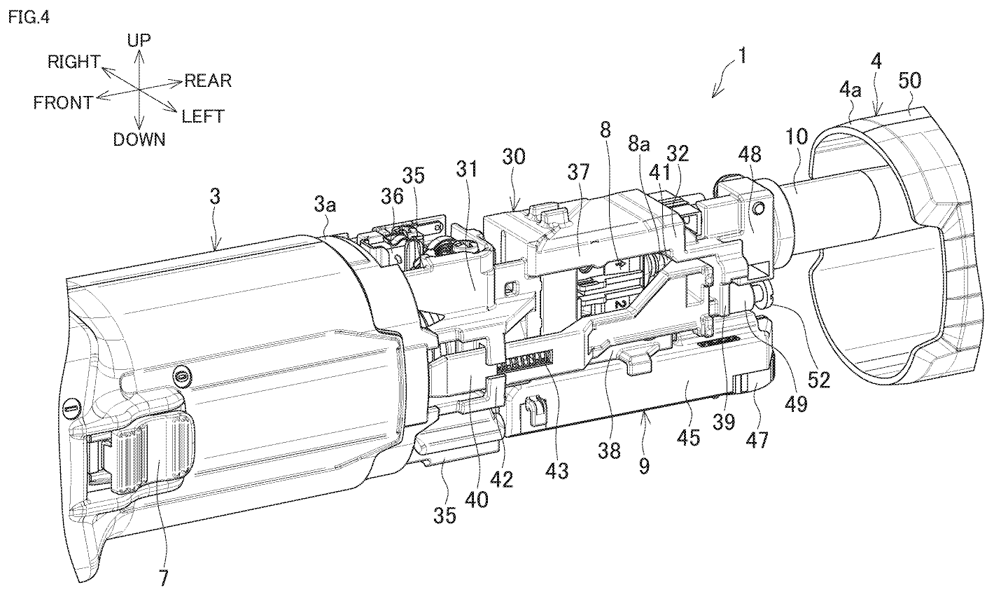

At a rear end of the motor housing 3, an inner housing portion 30 is integrally formed, as also illustrated in FIG. 4. An inner housing portion 30 extends rearwardly within the rear cover 4. The inner housing portion 30 includes a front bearing holder 31 and a rear switch holder 32.

The bearing holder 31 is cylindrical, coaxial with an axis L of the motor shaft 14 and holds a bearing 33 to support a rear end of the motor shaft 14. A magnet 34 for detection of a rotation speed is attached to a rear end of the motor shaft 14, which extends rearwardly from the bearing 33. In the bearing holder 31 on the front side of the bearing 33, brush holders 35 are provided at upper and lower positions, respectively. The brush holders 35 hold brushes 36 that abut the commutator 13. The brush 36 is one example of the electrical component other than the motor of the present disclosure.

The switch holder 32 extends toward a rear from the bearing holder 31. The switch holder 32 includes an upper holding plate 37, a lower holding plate 38, and a rear holding plate 39.

The upper holding plate 37 and the lower holding plate 38 have a rectangular shape in plain view and extend rearward, spaced in the up-down direction, in an orientation parallel to a plane defined by front-rear and left-right directions. The rear holding plate 39 interconnects rear ends of the upper holding plate 37 and the lower holding plate 38 in the up-down direction.

The switch 8 is held between the upper holding plate 37 and the lower holding plate 38. The switch 8 is a push switch that performs an ON operation when a protruding button portion 8a is pressed. The switch 8 is supported in an orientation in which the button portion 8a faces the rear. The switch 8 is one example of the electrical component other than the motor disclosed of the present disclosure.

A slide bar 40 is provided on the left side of the inner housing portion 30 within the motor housing 3 and the rear cover 4. A front end of the slide bar 40 is connected to the switch knob 7. The rear end of the slide bar 40 is bent to a right side at a rear of the switch 8, thereby forming a pressing portion 41 that faces the button portion 8a from rear. The slide bar 40 is biased toward a retracted position, in which the pressing portion 41 is adjacent to the button portion 8a, by a coil spring 43 interposed between a support portion 42 provided on the inner housing portion 30 and the slide bar 40. Therefore, when the switch knob 7, which is in the retracted position together with the slide bar 40, is slid forward, the slide bar 40 advances and the pressing portion 41 presses the button portion 8a, thereby turning ON the switch 8.

The controller 9 is held on a lower surface of the lower holding plate 38. The controller 9 includes a casing 45 having a rectangular shape in plain view with an opening on the underside, and a control circuit board 46 housed inside the casing 45. The control circuit board 46 includes a CPU and a memory connected to the CPU, is electrically connected to the motor 6 and the switch 8 and controls the motor 6. The controller 9 has functions of constant-speed control, soft start, and restart prevention.

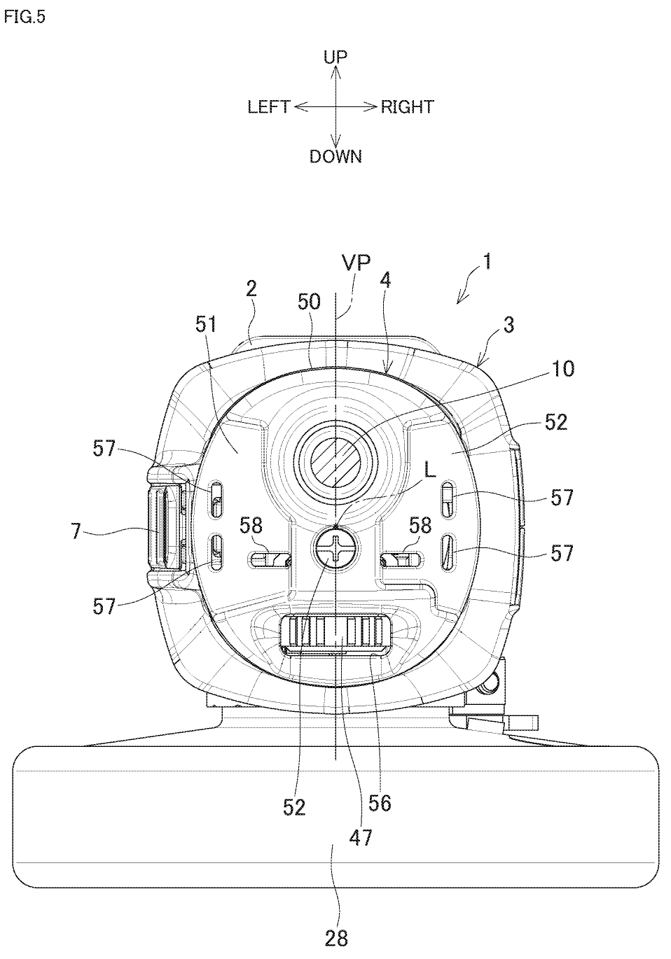

An adjustment dial 47 is provided at a rear of the control circuit board 46. As also illustrated in FIG. 5, the adjustment dial 47 has a rear portion exposed on the rear surface of a rear wall portion 51, to be described later, of the rear cover 4. By a rotation operation of the adjustment dial 47, the rotational speed of the motor 6 can be adjusted.

The rear holding plate 39 includes a cord holder 48 and a screw boss 49. The power cord 10 is connected to the cord holder 48. The power cord 10 extends rearward through the rear wall portion 51 of the rear cover 4. The screw boss 49 extends rearward below the cord holder 48.

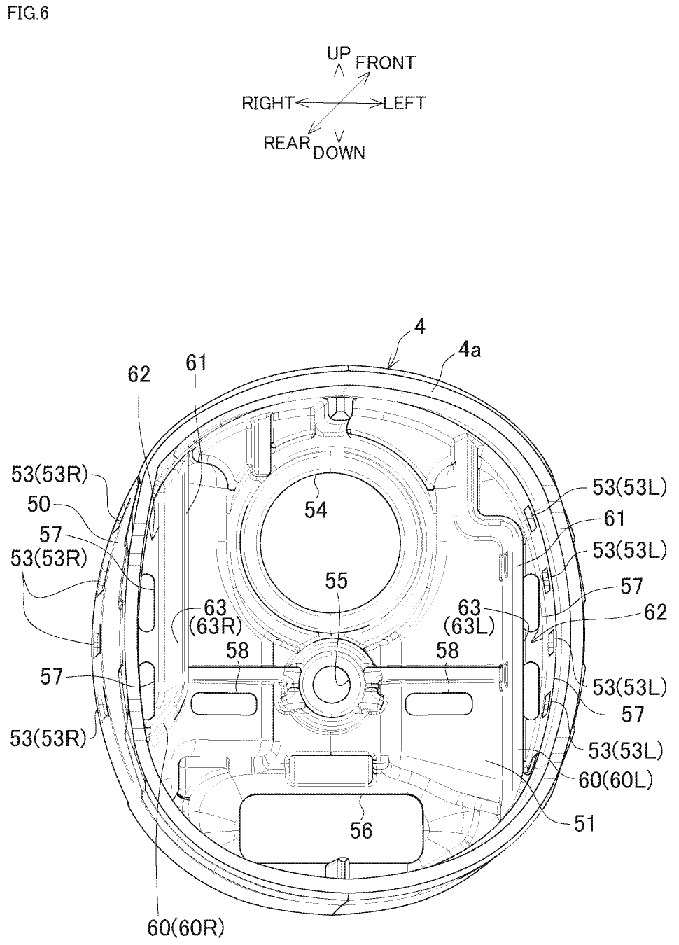

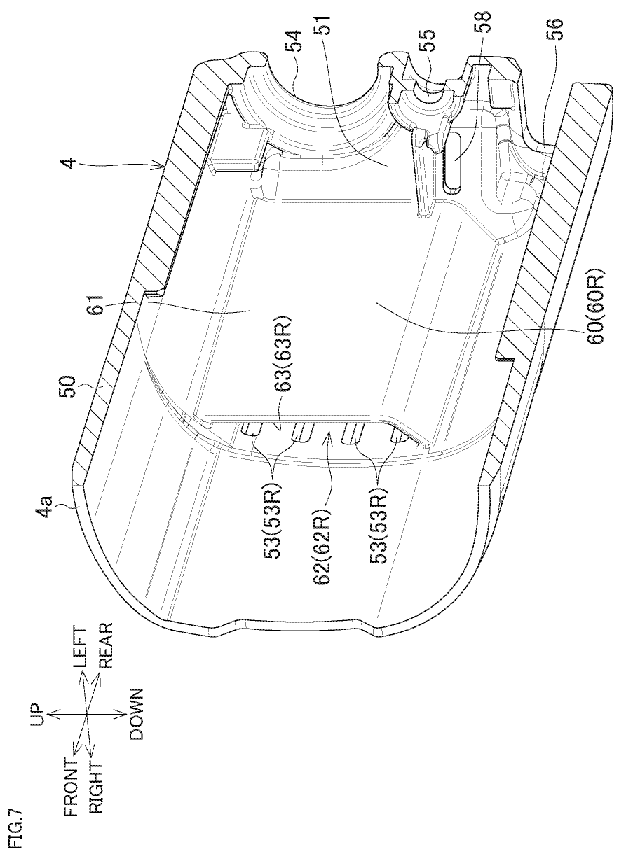

As also illustrated in FIGS. 6 and 7, the rear cover 4 is formed as a bottomed cylindrical tube with a front opening, having a cylindrical peripheral wall portion 50 and the rear wall portion 51 that closes the rear end of the peripheral wall portion 50. The peripheral wall portion 50 is formed into a shape that covers the inner housing portion 30 from the rear. The rear cover 4 is assembled to the inner housing portion 30 by fitting a front end 4a over a rear end 3a of the motor housing 3 and screwing screws 52, which have been passed through the rear wall portion 51 from the rear, into the screw boss 49. In the assembled state, the bearing holder 31, which holds the brushes 36 and the switch holder 32, which holds the switch 8 and the controller 9, are housed within the rear cover 4.

A plurality of side intake ports 53 are provided on left and right sides of the peripheral wall portion 50. At the central position in the left-right direction of the rear wall portion 51, from the top to the bottom, a cord through-hole 54 through which the power cord 10 passes, a screw through-hole 55 through which the screw 52 passes, and an operation window 56 that exposes the adjustment dial 47 are respectively formed. A plurality of outer rear intake ports 57 and a plurality of inner rear intake ports 58 are provided on both the left and right sides of the rear wall portion 51.

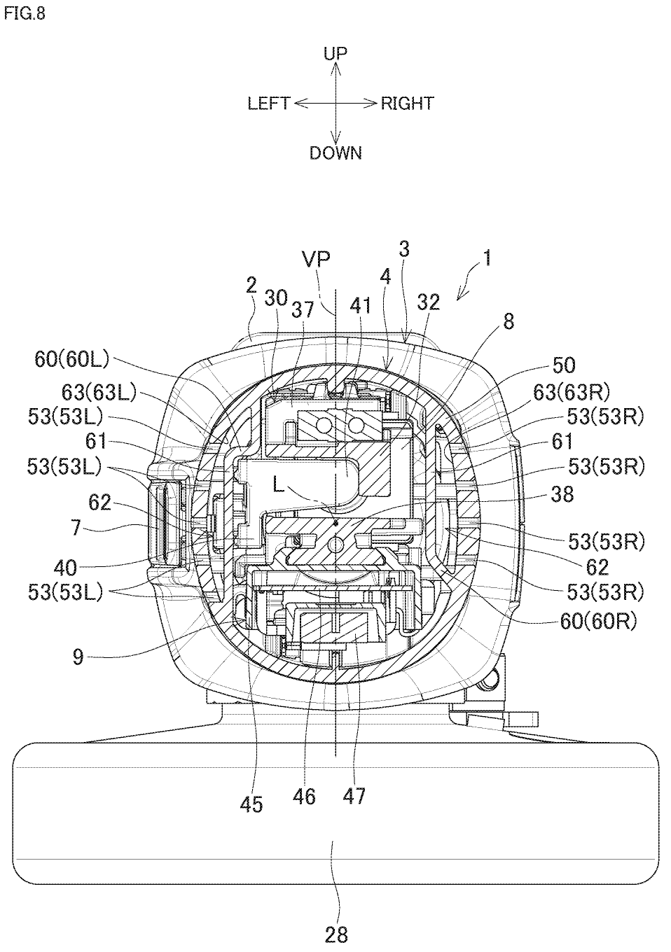

The side intake port 53 is slit-shaped, elongated in the front-rear direction at the rear of the peripheral wall portion 50, and is formed through in the left-right direction. As also illustrated in FIG. 8, the side intake ports 53 are formed, in a plurality, namely five on the left side and four on the right side, at equal intervals in the circumferential direction of the peripheral wall portion 50. Hereinafter, when distinguishing between the left and the right, the left side intake port will be referred to as 53L and the right side intake port as 53R. In the case of the other components as well, the symbols "L" and "R" are affixed to distinguish the left and right sides. The side intake port 53 is one example of the intake opening of the intake air passage of the present disclosure.

As illustrated in FIG. 3, the side intake port 53 is formed such that a right-side intake port 53R is longer in the front-rear direction than a left side intake port 53L. The right-side intake port 53R is located forward of the left side intake port 53L. As illustrated in FIG. 5, the outer rear intake ports 57 are provided near the left and right outer peripheral edges of the rear wall portion 51, two on each side in left-right symmetry about a virtual plane VP, which includes the axis L and is defined by the front-rear and up-down directions. The outer rear intake ports 57 have the oblong shape extending in the up-down direction, with two on the left and two on the right arranged on the straight line in the up-down direction. The outer rear intake port 57 is one example of the second intake opening of the intake air passage of the present disclosure.

The inner rear intake ports 58 are provided on the inner sides of the left and right outer rear intake ports 57, one apiece, symmetrically with respect to the virtual plane VP. At a position slightly higher than a top of the casing 45 of the controller 9, the inner rear intake port 58 has the oblong shape extending in the left-right direction.

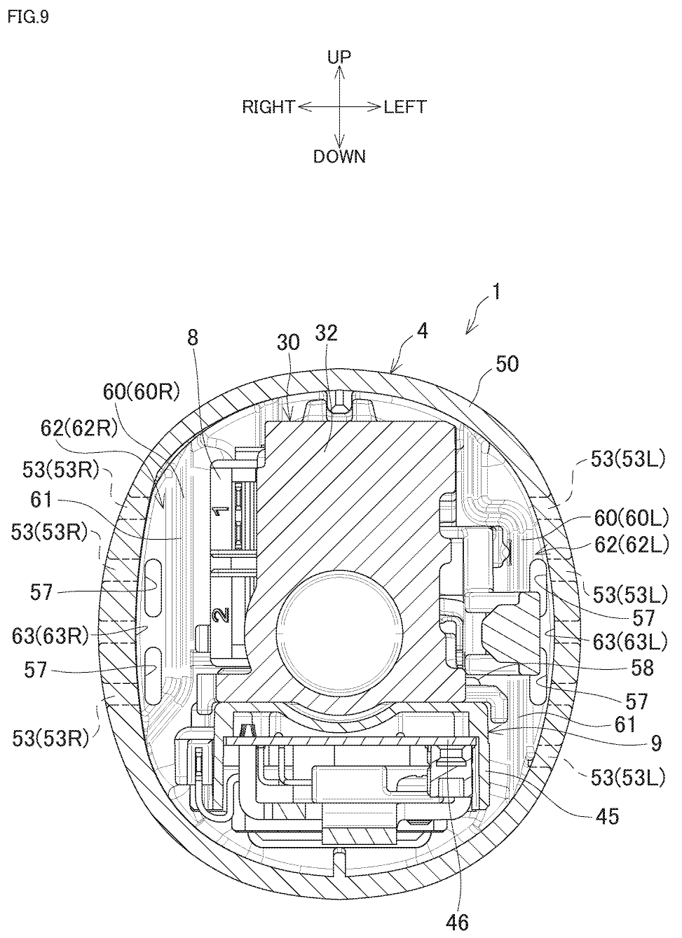

Inner wall portions 60 are formed on the left and right inner surfaces of the rear cover 4. The inner wall portion 60 is a plate formed integrally with the rear cover 4 on the inner sides of the formation regions of the side intake ports 53 and the outer rear intake ports 57, as illustrated in FIGS. 7 to 9. The inner wall portion 60 includes a flat portion 61 parallel to the virtual plane VP and is partially bent so as not to interfere with the switch holder 32. The virtual plane VP is orthogonal to the switch 8 and the controller 9. The spindle 5 is also located on the virtual plane VP.

The upper ends of the inner wall portions 60 are joined to the inner surface of the peripheral wall portion 50 at the position above the uppermost side intake ports 53. The lower ends of the inner wall portions 60 are joined to an inner surface of the peripheral wall portion 50 at the position below the lowermost side intake ports 53. Thus, the regions where the left and right-side intake ports 53 are formed are opposite the inner wall portions 60. The rear ends of the inner wall portions 60 are joined to an inner surface of the rear wall portion 51 at a position inward of the outer rear intake ports 57. The front ends of the inner wall portions 60 protrude to a position slightly forward of the front ends of the side intake ports 53. However, corresponding to the side intake ports 53L, 53R, the respective lengths of which differ, the inner wall portion 60R on the right side extends farther in the forward direction than the inner wall portion 60L on the left side.

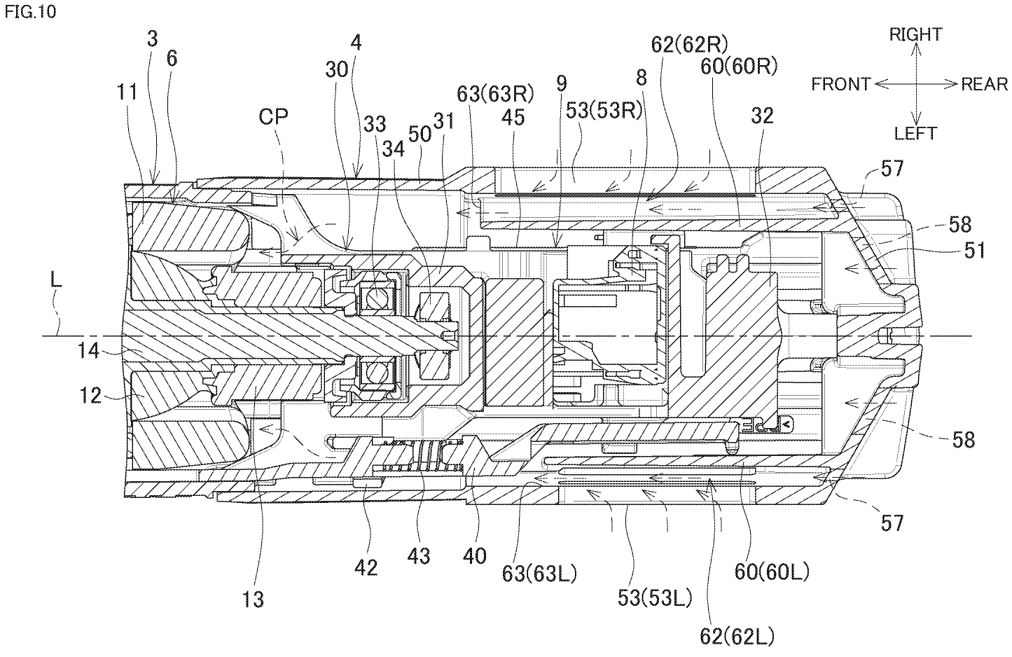

Thus, within the peripheral wall portion 50, intake air passages 62 are formed such that the intake air passages communicate with the side intake ports 53 at the left and right sides and communicate the outer rear intake ports 57 at the rear side and are partitioned from a housing region for the switch holder 32. The intake air passages 62 have a tubular shape extending in the front-rear direction, and the cross-sectional shape perpendicular to the axis L of the motor shaft 14 is a flat-plate shape parallel to the flat portion 61 of the inner wall portion 60. The intake air passages 62 also correspond to the inner wall portions 60L, 60R having different lengths, and as illustrated in FIG. 10, a right-side intake air passage 62R is formed to extend farther forward than a left side intake air passage 62L.

Outlet openings 63 that extend in the up-down direction and open forward are formed in the space between the front ends of the left and right inner wall portions 60L, 60R and the left and right inner surfaces of the peripheral wall portion 50. The outlet openings 63, both the left and the right, are located forward of the switch 8 and are close to the motor shaft 14. On both the left and the right, the outlet openings 63 are located between the motor 6 and the central portion of the controller 9 in an axial direction of the axis L. In other words, as is clear from FIG. 3, which also illustrates a front-end position F, a rear end position R, and a central position M in the front-rear direction including the center Z of the controller 9 that can be seen in FIG. 2, the outlet openings 63 are both located, in the axial direction of the axis L, in the region between the motor 6 and the central position M, namely, the central portion, of the controller 9.

However, due to the difference in the lengths of the inner wall portions 60L, 60R, an outlet opening 63R on the right side is located closer to the radially outer side of the rear end of the motor shaft 14 than an outlet opening 63L on the left side.

Thus, within the grinder 1, the cooling passage CP (FIG. 10) is formed, in which the air drawn in from the side intake ports 53 and the rear intake ports 57, 58 passes through the motor 6 and then flows to the exhaust port 23 with the rotation of the fan 16. However, the air drawn in from the side intake ports 53 and the outer rear intake ports 57 flows toward the front from the outlet openings 63 after passing through the intake air passages 62, which are partitioned within the rear cover 4. Therefore, the air passing through the intake air passages 62 will scarcely touch the switch 8 and the controller 9.

In the grinder 1 configured as described above, when the ON operation of the switch 8 is performed by sliding the switch knob 7 in the forward direction, the controller 9 drives the motor 6 to rotate the motor shaft 14. Then, the spindle 5 rotates via the bevel gears 15, 22, and the tip tool 27 rotates, thereby allowing the grinding operations, and the like.

When the fan 16 rotates as the motor shaft 14 rotates, the air is drawn into the side intake ports 53 from the radially outer side of the motor shaft 14 as viewed in the axial direction of the axis L, and the air is drawn into the inner and outer rear intake ports 57, 58 from the rear, thereby generating the airflow through the cooling passage CP as described above. Of the airflow, the air drawn in from each outer rear intake port 57, as illustrated by the dashed arrows in FIG. 10, passes through the left and right intake air passages 62, respectively, flows forward from the outlet openings 63, passes through the motor 6, and then becomes the airflow that is discharged from the exhaust port 23. Thus, the motor 6 is cooled. The air drawn in through the respective inner rear intake ports 58 become the airflow that is discharged through the exhaust port 23 after sequentially passing through the casing 45 of the controller 9 and the motor 6. The motor 6 and the controller 9 are thus cooled by the airflow through the cooling passage CP.

At this time, even if the foreign matter such as dust is suctioned in with the air from each of the side intake ports 53 and each of the outer rear intake ports 57, the foreign matter flows forward without coming into contact with the switch 8 and the controller 9 by passing through the intake air passages 62 that are internally partitioned. Each of the inner rear intake ports 58 is formed inside the left and right inner wall portions 60, but the overall opening area is much smaller than those of the side intake port 53 and the outer rear intake port 57, so that the foreign matter drawn in, if any, is minimal. Therefore, the possibility that the foreign matter drawn into the rear cover 4 adheres to the switch 8 or the controller 9 and causes the failure due to the short circuit or the like is reduced.

Even if the operator's hand grasping the peripheral wall portion 50 of the rear cover 4 blocks the side intake ports 53, not all of the left and right-side intake ports 53, which have wide opening regions, are blocked, and the outer rear intake port 57 remains unblocked, such that the intake of outside air necessary for cooling is still ensured. When the forward sliding of the switch knob 7 is released, the slide bar 40 is retracted by the biasing force of the coil spring 43, thereby releasing the pressing of the button portion 8a by the pressing portion 41. Therefore, the switch 8 turns OFF, stopping the drive of the motor 6.

Thus, the grinder 1 of the above-described Embodiment 1 includes the motor housing 3 that houses the motor 6, the rear cover 4 that is positioned on the axis L of the motor shaft 14 of the motor 6 and houses the electrical components other than the motor 6, namely, the switch 8, the controller 9, the brush 36, and the power cord 10, and the fan 16 that rotates with the drive of the motor 6. The cooling passage CP is formed in the motor housing 3 and the rear cover 4 through which the air drawn in by the rotation of the fan 16 passes.

In the rear cover 4, the intake air passage 62 is formed as a part of the cooling passage CP. The intake air passage 62 includes the outer rear intake port 57 for drawing in air from the radially outer side of the motor shaft 14 as viewed along the axial direction of the axis L and the outlet opening 63 that exhausts air toward the motor 6 side and is located close to the motor 6 in the axial direction of the axis L.

According to the configuration, since the outlet opening 63 of the intake air passage 62 is close to the motor 6, the foreign matter that is drawn in with the outside air from the side intake port 53 and the outer rear intake port 57 during the operation is less likely to adhere to the electrical components such as the switch 8 and the controller 9. Therefore, the possibility that the foreign matter becomes the cause of the failure due to the short circuit or the like is reduced. Additionally, since the air passing through the intake air passage 62 is exhausted toward the motor 6, the motor 6 is efficiently cooled. Therefore, the suppression of the occurrence of the failure caused by the foreign matter drawn into the cooling passage CP is possible, and the suppression of the decrease in the cooling performance is also possible.

The outlet opening 63 is located between the motor 6 and the central position M of the controller 9 in the axial direction of the axis L.

Thus, the airflow can contact the motor 6 from a position close to the motor 6.

The intake air passage 62 is formed into a tubular shape extending in the axial direction of the axis L by the peripheral wall portion 50 of the rear cover 4 and the inner wall portion 60 provided inside the peripheral wall portion 50.

Thus, the airflow can be directed smoothly toward the front, whereby the efficient cooling becomes possible.

The side intake port 53 is provided in the peripheral wall portion 50.

Therefore, securing the wide opening region at the peripheral wall portion 50 allows the intake of the necessary air and enables the efficient cooling.

The side intake port 53 provided in the peripheral wall portion 50 faces the inner wall portion 60.

Accordingly, even if the foreign matter enters through the side intake port 53, it can be shielded by the inner wall portion 60.

The inner wall portion 60 includes the flat portion 61 parallel to the axial direction of the axis L.

Therefore, the air drawn in from the side intake port 53 can be guided to flow smoothly toward the front along the flat portion 61.

The flat portion 61 is parallel to the virtual plane VP that has the axis L and intersects the switch 8 and the controller 9.

Therefore, the inner wall portion 60 can be provided by utilizing the dead space on the left and right outer sides of the switch 8 and the controller 9, thereby suppressing the rear cover 4 from becoming larger.

In the intake air passage 62, the cross-sectional shape perpendicular to the axis L is the flat-plate shape parallel to the flat portion 61.

Therefore, the intake air passage 62 can be provided by utilizing the dead space on the left and right outer sides of the switch 8 and the controller 9, thereby suppressing the enlargement of the rear cover 4.

The outer rear intake port 57, which is in communication with the intake air passage 62, is provided on the rear wall portion 51 of the rear cover 4, which is on a side opposite to the motor.

Therefore, it is possible to cause the air in the intake air passage 62 to flow linearly, leading to the improvement in the cooling efficiency.

The outer rear intake port 57 has an oblong shape extending parallel to the flat portion 61.

Accordingly, the outer rear intake port 57 that connects to the intake air passage 62 can be provided compactly.

The spindle 5 is provided orthogonal to the motor shaft 14, and the spindle 5 is disposed on the virtual plane VP.

Therefore, the spindle 5 can be placed in the dead space on the virtual plane VP, suppressing the enlargement in the left-right direction.

The side intake port 53 formed in the peripheral wall portion 50 extends through in the direction perpendicular to the virtual plane VP.

Thus, even in the case where the hand grasping the peripheral wall portion 50 contacts the side intake port 53, it becomes less likely that the reduction in the airflow rate to be drawn in will occur.

The motor 6 is a brushed motor, and the brush 36 is disposed at a position other than on an extension of the intake air passage 62.

Therefore, the brush 36 can be placed in the dead space that does not interfere with the cooling passage CP, whereby the suppression of the enlargement can be achieved and the decrease in the cooling efficiency can be suppressed.

The electrical component is the controller 9 that controls the brushed motor.

Thus, the adhesion of the foreign matter to the controller 9 can be effectively suppressed.

Next, a modification of Embodiment 1 will be described.

The number of the side intake ports that serve as the intake openings is not limited to the above example and may be increased or decreased as needed. The same number may be employed on both of the sides.

The shape of the side intake port may also be such that the length is the same on the left and right sides. A plurality of the side intake ports may be arranged on a straight line in the front-rear direction with the front-rear length shorter than in the above example.

The side intake port is not limited to the oblong shape, and may alternatively be of the other shapes, such as an elliptical shape or a circular shape. The side intake ports of the different shapes and the different sizes may be mixed and arranged.

The number and the shape of the outer rear intake ports that serve as the second intake openings can also be modified as needed and are not limited to the above example. For example, the outer rear intake port may be configured as the one oblong shape or a plurality of circular shapes. The second intake opening may be omitted.

The shape of the inner wall portion is also not limited to the example described above. The inner wall portion may have a flat-plate shape, namely the flat portion alone, extending in the up-down direction without bending, provided that the interference with the electrical component on the central portion is avoided.

Next, Embodiment 2 of the present disclosure will be described. However, the same components as in Embodiment 1 are denoted by the same reference numerals, and the duplicate description is omitted.

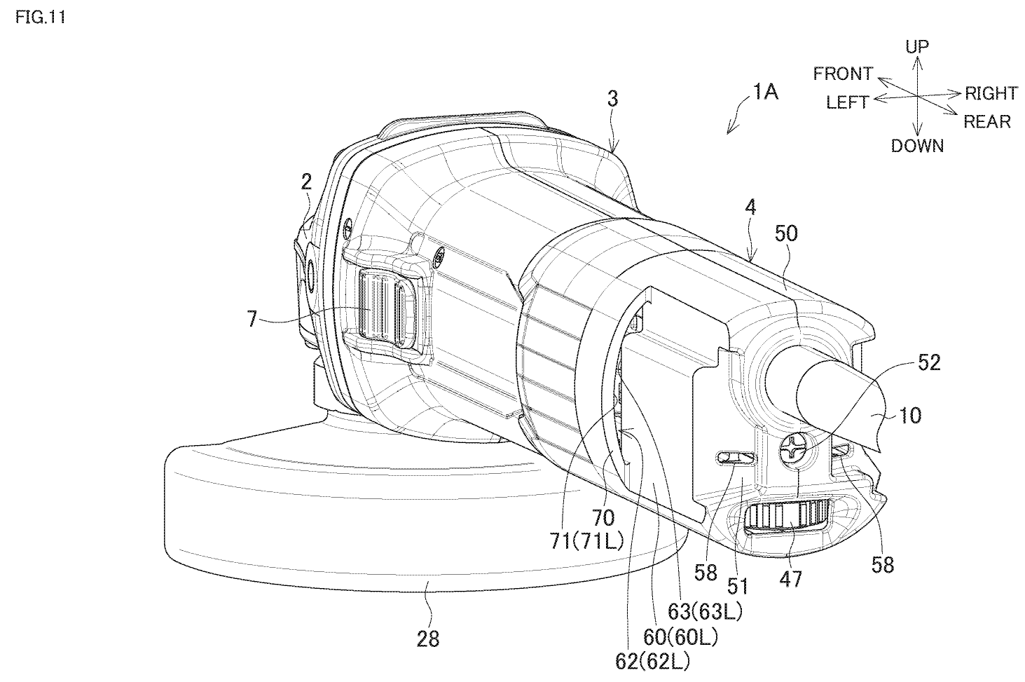

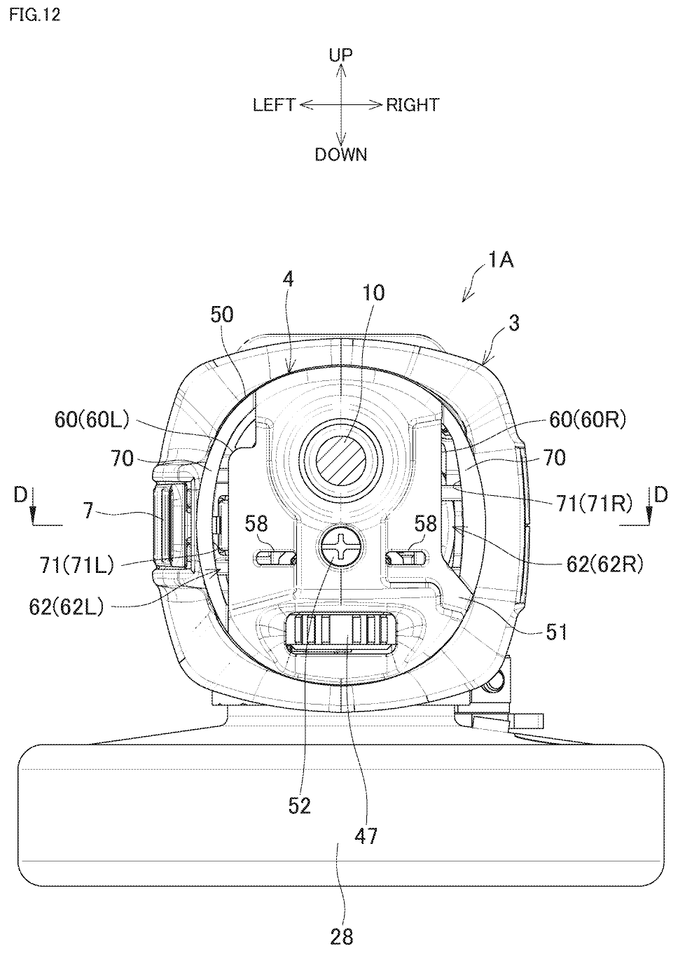

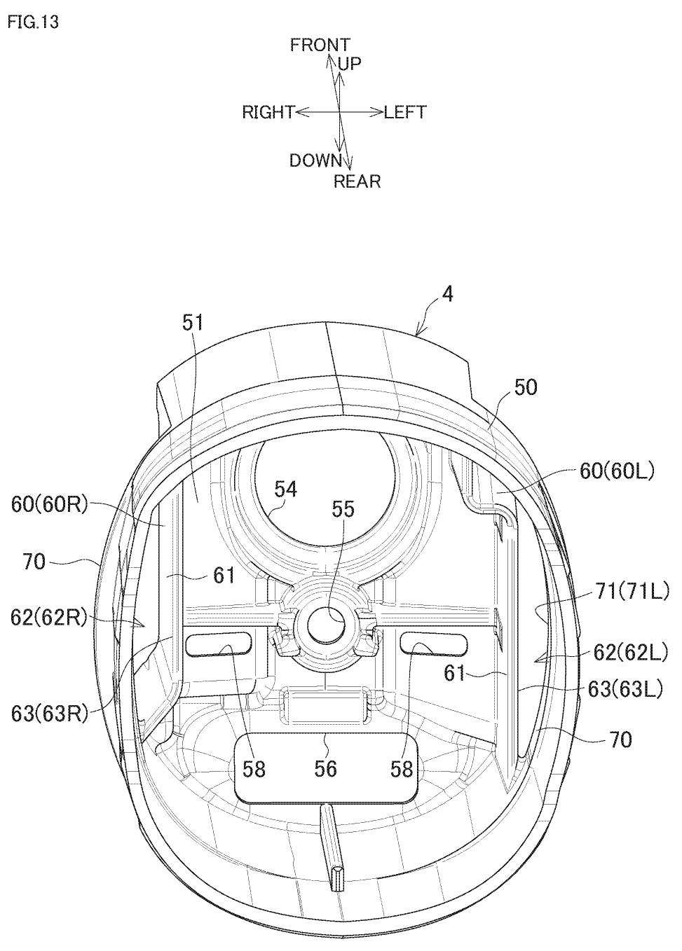

In the above-described Embodiment 1, the side intake port is provided on the side surface of the peripheral wall portion 50, but in the rear cover 4 of a grinder 1A illustrated in FIGS. 11 through 13, the portion that covers the outer region of the inner wall portions 60 in the peripheral wall portion 50 is omitted. Specifically, the structure is such that the inner wall portions 60 also serve as the peripheral wall portion and are exposed on the left and right sides.

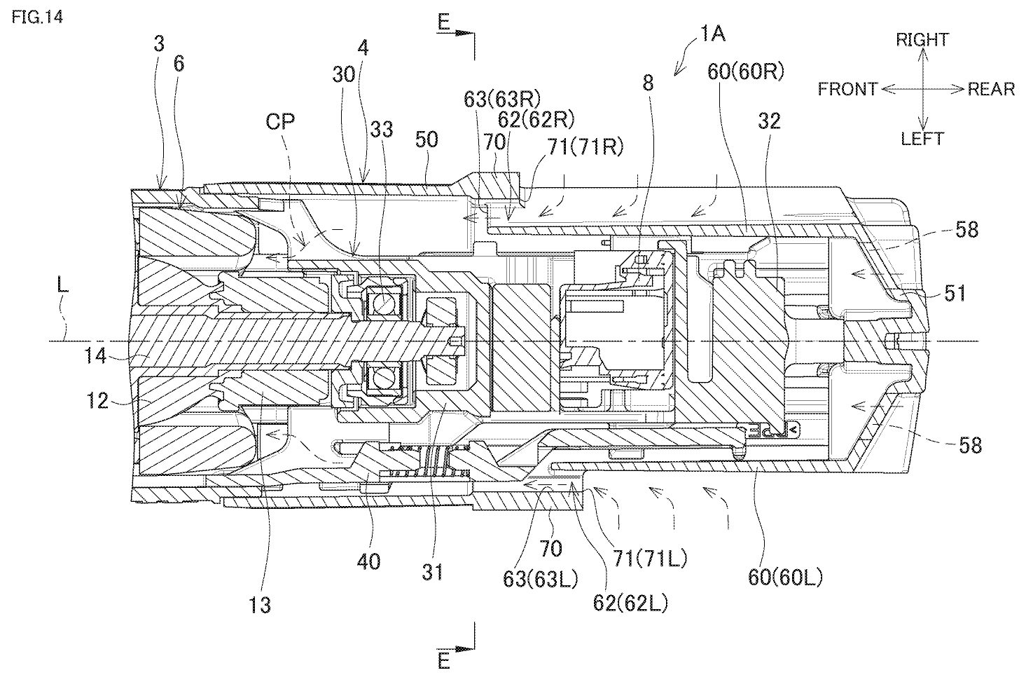

Here, as also illustrated in FIG. 14, the rear end of the peripheral wall portion 50 on the front side of the inner wall portions 60 is formed as an overlapping portions 70 that overlap the front end of the inner wall portions 60 from the left and right outer sides.

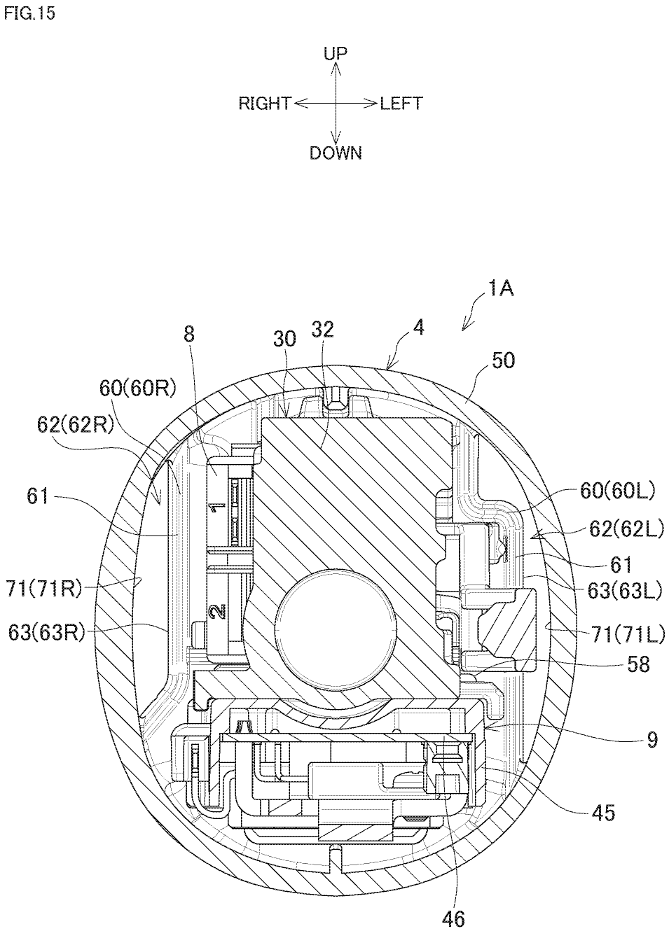

Thus, between the rear ends of the overlapping portions 70 and the inner wall portions 60, behind the outlet openings 63, side intake ports 71 open to form the intake air passages 62 that are shorter front-to-rear than in Embodiment 1. However, due to the difference in the left and right lengths of the inner wall portions 60L, 60R as in Embodiment 1, a right side intake port 71R is located farther forward than a left side intake port 71L. As illustrated in FIG. 15, the side intake ports 71 are of a plate shape that extends in the up-down direction and have the same shape as the outlet openings 63. Only the inner rear intake ports 58 are formed in the rear wall portion 51, and the outer rear intake port is not formed.

In the grinder 1A, when the fan 16 rotates with the rotation of the motor shaft 14, as indicated by the dashed arrow in FIG. 14, a portion of the air flowing through the cooling passage CP is suctioned into the side intake ports 71 from the radially outer side of the motor shaft 14 when viewed in the axial direction of the axis L. The portion of the air passes through the left and right intake air passages 62, respectively, then flows forward from the outlet openings 63, passes through the motor 6, and is thereafter discharged as the airflow from the exhaust port 23. Thus, the motor 6 is cooled. The air drawn in from the inner rear intake port 58 becomes the airflow that is discharged from the exhaust port 23 after sequentially passing through the casing 45 of the controller 9 and the motor 6. Thus, the airflow passing through the interior cools the motor 6 and the controller 9.

Even if the foreign objects are drawn in with the air from the side intake ports 71, the foreign objects flow forward without contacting the sides of the switch 8 and the controller 9 because they pass through the intake air passages 62, which are internally partitioned. The possibility of the foreign matter being suctioned in through the inner rear intake port 58 is slight, as in Embodiment 1. Therefore, the possibility of the foreign matter suctioned into the rear cover 4 adhering to the switch 8 or the controller 9 and causing the failure due to the short circuit or the like is reduced.

In particular, in Embodiment 2, since the side intake ports 71 are not formed on the outer periphery of the peripheral wall portion 50, the hands of the operator grasping the peripheral wall portion 50 do not block the side intake ports 71, and the intake of the outside air necessary for the cooling becomes possible.

Thus, in the grinder 1A of the above-described Embodiment 2, the intake air passage 62 is also formed in the rear cover 4 as a part of the cooling passage CP. The intake air passage 62 includes the side intake port 71 that draws in air from the radially outer side of the motor shaft 14 and the outlet opening 63, which is located near the motor 6 in the axial direction of the axis L, discharges air toward the motor 6 side.

According to the configuration, since the outlet opening 63 of the intake air passage 62 is adjacent to the motor 6, the foreign matter drawn in with the outside air through the side intake port 71 during operation is less likely to adhere to the electrical components such as the switch 8 and the controller 9. Therefore, the possibility of the foreign matter becoming the cause of the failure due to the short circuit or the like is reduced. Additionally, since the air that passes through the intake air passage 62 is discharged toward the motor 6, the motor 6 is efficiently cooled. In particular, since the side intake port 71 that opens in the central portion of the peripheral wall portion 50 is not blocked by the hands of the operator gripping the rear cover 4, the decrease in the airflow rate drawn in is suppressed. Therefore, both the occurrence of the failure caused by the foreign matter suctioned into the cooling passage CP and the decrease in the cooling performance can be suppressed.

Next, a modification of Embodiment 2 will be described.

In the above example, the lengths of the inner wall portions may also be the same on the left and right sides, and the positions of the side intake ports may be the same on the left and right sides. The shape of the side intake port, namely the intake air passage, can also be changed as needed to match the change in the shape of the inner wall portion.

In the above-described example, the side intake port is formed by providing the overlapping portion at the rear end of the peripheral wall portion, which overlaps the front end of the inner wall portion, but the overlapping portion may be omitted and the rear end of the peripheral wall portion and the front end of the inner wall portion may be at the same position in the front-rear direction. The inner wall portion may be shortened such that the front end of the inner wall portion is positioned rearward of the rear end of the peripheral wall portion. In this case, the side intake ports open rearward and are inclined outward to the left and right sides.

The following is a description of modifications common to Embodiments 1 and 2.

The intake air passage may be provided above or below the motor shaft, rather than on the left and right sides of the axis of the motor shaft. The intake air passage may be provided as one rather than the pair, or three or more may be provided.

The outlet opening of the intake air passage may be located forward of the electrical component rather than in the central portion of the electrical component.

The locations of the switch and the controller are not limited to the above-described examples. Contrary to the above example, the controller may be placed on the upper side and the switch on the lower side. Additionally, the controller and the switch may be arranged side by side in the left-right direction and oriented vertically. The shape of the inner housing portion can also be changed as needed.

The grinder may be a DC tool that uses a battery pack as a power supply rather than an AC tool that uses a commercial power supply.

The motor may be a brushless motor rather than the brushed motor.

The electric work machine is not limited to the grinder.

It may be any of other grinding and polishing tools, such as a polisher and a sander, or any of other power tools, such as a biscuit joiner, namely a joint cutters. It is not limited to the portable tool, but may also be the stationary tool placed on the floor to perform the work. Specifically, the present disclosure is applicable to the electric work machine that forms the cooling passage in the housing, through which the air flows with the rotation of the fan. Accordingly, the first housing and the second housing are not limited to being positioned in the front-rear direction with respect to the tip tool, but may also be positioned in the left-right direction or the up-down direction.

It is explicitly stated that all features disclosed in the description and/or the claims are intended to be disclosed separately and independently from each other for the purpose of original disclosure as well as for the purpose of restricting the claimed invention independent of the composition of the features in the embodiments and/or the claims. It is explicitly stated that all value ranges or indications of groups of entities disclose every possible intermediate value or intermediate entity for the purpose of original disclosure as well as for the purpose of restricting the claimed invention, in particular as limits of value ranges.

1. An electric work machine comprising:
a first housing that houses a motor;
a second housing that is disposed on an axis of a motor shaft of the motor and houses an electrical component other than the motor; and
a fan that rotates with a drive of the motor, wherein
a cooling passage through which air drawn by the rotation of the fan passes is formed in the first housing and the second housing, and
an intake air passage is formed in the second housing as a part of the cooling passage and includes an intake opening for drawing in air from a radially outer side of the motor shaft and an outlet opening for exhausting air toward the motor side in proximity to the motor in an axial direction of the axis.

2. The electric work machine according to claim 1, wherein
the outlet opening is positioned between the motor and a central portion of the electrical component in the axial direction of the axis.

3. The electric work machine according to claim 1, wherein
the intake air passage is formed in a tubular shape extending in the axial direction of the axis by a peripheral wall portion of the second housing and an inner wall portion provided inside the peripheral wall portion.

4. The electric work machine according to claim 3, wherein
at least a portion of the intake opening is provided in the peripheral wall portion.

5. The electric work machine according to claim 4, wherein
the intake opening provided in the peripheral wall portion faces the inner wall portion.

6. The electric work machine according claim 3, wherein
the inner wall portion includes a flat portion parallel to the axial direction of the axis.

7. The electric work machine according to claim 6, wherein
the flat portion is parallel to a virtual plane that includes the axis and intersects the electrical component.

8. The electric work machine according to claim 7, wherein
a cross-sectional shape perpendicular to the axis in the intake air passage has a flat-plate shape parallel to the flat portion.

9. The electric work machine according to claim 6, wherein
a second intake opening is provided at an end portion of the second housing, the end portion being on a side opposite to the motor, the second intake opening being in communication with the intake air passage.

10. The electric work machine according to claim 9, wherein
the second intake opening is oblong shaped and extends parallel to the flat portion.

11. The electric work machine according to claim 7, comprising
an output shaft inclined at a predetermined angle with respect to the motor shaft, the output shaft being positioned on the virtual plane.

12. The electric work machine according to claim 7, wherein
the intake opening provided in the peripheral wall portion penetrates in a direction orthogonal to the virtual plane having the axis and intersecting the electrical component.

13. The electric work machine according to claim 1, wherein
the motor is a brushed motor, and the brush is positioned at a position other than on an extension of the intake air passage.

14. The electric work machine according to claim 13, wherein
the electrical component is a controller that controls the brushed motor.

15. An angle tool comprising:
a front housing that includes an output shaft in an up-down direction on which a tip tool is mounted at a lower end of the output shaft;
a first housing that is positioned behind the front housing, extends in a front-rear direction, and houses a motor including a motor shaft having an axis in the front-rear direction;
a second housing that is positioned behind the first housing, extends in the front-rear direction, and houses an electrical component other than the motor;
a fan that rotates with a drive of the motor; and
a cooling passage formed in the first housing and the second housing, air drawn by the rotation of the fan passing through the cooling passage, wherein
an intake air passage is formed as a part of the cooling passage in the second housing, has an intake opening that opens radially outer side of the motor shaft and an outlet opening that opens toward a front in the axial direction of the axis, and is proximate to the motor.
